(19) United States
(12) Patent Application Publication
(10) Pub. No.: US 2010/0141944 A1
(43) Pub. Date: Jun. 10, 2010

(54) APPARATUS AND METHOD FOR THE SPECTRAL DIAGNOSIS OF SUBSTANCES AND/OR SURFACES

(76) Inventor: Peter Zipfl, Aalen-Fachsenfeld (DE)

Correspondence Address: GRAY ROBINSON, P.A., P.O. Box 2328, FT. LAUDERDALE, FL, 33303-9998, US

(21) Appl. No.: 12/524,420

(22) PCT Filed: Jan. 31, 2008
(86) PCT No.: PCT/EP08/00763

§ 371 Date: Feb. 16, 2010

(30) Foreign Application Priority Data
Jan. 31, 2007 (DE) 10 2007 005 642.9

(51) Int. Cl. G01J 3/28; G01N 21/27; G01N 21/31

(52) U.S. Cl. 356/328

(57) ABSTRACT

An apparatus for the spectral diagnosis of substances and/or surfaces includes a radiation source which can be variably adjusted over a predetermined spectral range and whose emitted radiation is focused onto a sample to be examined, wherein a first optical sensor unit detects a radiation component, which is influenced by the sample to be examined, as a useful signal and forwards it to an evaluation and control unit, and to an associated method. The radiation source comprises a light-emitting diode with a predetermined emission wavelength which can be varied between a first emission wavelength and a second emission wavelength by a dynamic change in temperature of the light-emitting diode within the predetermined spectral range, wherein a second optical sensor unit detects a component of the emitted radiation as a reference signal and forwards it to the evaluation and control unit for error compensation purposes.

### CROSS REFERENCE TO RELATED APPLICATIONS

This is a U.S. National Phase Entry under 35 U.S.C. §371 of, and claims priority under 35 U.S.C. Sections 119(a)-d), 120, 363 and 365 to, International Application No. PCT/EP2008/000763, filed Jan. 31, 2008 which designated the United States and at least one other country in addition to the United States and claimed priority to German Application No. 10 2007 005 642.9 filed Jan. 31, 2007. The specifications of these applications are hereby expressly incorporated by reference in their entirety to form a part of this application.

### FIELD OF THE INVENTION

The invention relates to an apparatus for the spectral diagnosis of substances and/or surfaces of the type defined in greater detail in the preamble of claim 1, and to an associated method.

In conventional apparatuses and methods for the spectral diagnosis of substances and/or surfaces, in general a broadband radiation that is reflected by a sample to be examined or transmitted by the sample to be examined is spectrally decomposed. This is done in a traditional spectrometer arrangement for example by means of optical gratings in polychromators or by means of optical filters for small wavelength ranges. The determined spectral composition of the transmitted or reflective radiation then gives indications about the composition of the sample examined.

### BACKGROUND OF THE INVENTION

As an alternative, as is known for example from EP 1 466 827 A2, the sample to be examined can be successively irradiated by a plurality of narrowband radiation sources having different emission wavelengths, wherein the analysis is effected in correlation with the respective radiation source and can be assigned to a specific wavelength.

Furthermore, it is possible to use tunable lasers, such as e.g. dye lasers or lasers with acoustic or optical modulators or with other active methods for tuning the emission wavelength, as radiation sources having a (quasi-) continuous tuning of the wavelength.

However, the traditional grating spectrometer arrangement, the implementation of the apparatus with a plurality of narrowband radiation sources and optical filters, and also the use of lasers having active tuning of the wavelength require a very high equipment outlay which in part is difficult to obtain and to construct and is thus very expensive.

In practice, however, it is often not necessary to determine a broadband spectrum of a sample to be examined in order for example to determine a multiplicity of constituents, as is done by the conventional apparatuses described above. It often suffices just to determine the presence or the concentration of a single substance in the sample to be examined, which can be registered by analysis of a very narrow spectral range.

### SUMMARY OF THE INVENTION

It is an object of the present invention, therefore, to specify an apparatus and a method for the spectral diagnosis of substances and/or surfaces which, with minimal equipment outlay, determine the concentration or the presence of a predetermined substance in a sample to be examined.

This object is achieved according to the invention by means of an apparatus for the spectral diagnosis of substances and/or surfaces comprising the features of claim 1 and by means of, an associated method comprising the features of claim 19.

Advantageous embodiments and developments of the invention are specified in the dependent claims.

The radiation source according to the invention, comprising a light emitting diode having a predetermined emission wavelength, makes it possible, by means of a dynamic change in temperature of the light emitting diode, to alter the emission wavelength of the emitted radiation within a predetermined spectral range between a first emission wavelength and a second emission wavelength. The emitted radiation is substantially focused onto a sample to be examined, wherein a first optical sensor unit detects a first portion of the emitted radiation, said first portion being influenced by the sample to be examined, as a useful signal and a second optical sensor unit detects a second portion of the emitted radiation as a reference signal and forwards it to an evaluation and control unit for error compensation purposes. It is thus possible for example to compensate for systematic errors that can arise in the course of the shift in the emission wavelength of the emitted radiation for example as a result of a thermal influencing of the irradiance.

The embodiment of the radiation source as a light emitting diode advantageously enables the technically simple tuning or shifting of the emission wavelengths of the radiation generated by the light emitting diode by means of the dynamic change in temperature of the light emitting diode. This advantageously results in an extremely simple and cost-effective arrangement for spectral measurement in a limited wavelength range. The dynamic change in temperature of the light emitting diode corresponds for example to a dynamic heating of the light emitting diode, whereby the emission wavelength of the emitted radiation can be altered from a lower emission wavelength to an upper emission wavelength. In addition or as an alternative, the dynamic change in temperature of the light emitting diode can correspond to a dynamic cooling of the light emitting diode, whereby the emission wavelength of the emitted radiation can be altered from the upper emission wavelength to the lower emission wavelength.

A further advantage results from the fact that customary light emitting diodes that are commercially available with emission wavelengths between the far UV range (ultraviolet range) and the IR range (infrared range) can be used as the radiation source. In addition, the apparatus according to the invention can advantageously be miniaturized and integrated, which enables implementation in large numbers.

In one advantageous embodiment of the invention, it can be provided that the evaluation and control unit relates the useful signal to the reference signal and, for further evaluation purposes, generates an evaluation signal in which the thermal dependence of the irradiance and/or the thermal dependence of the spectral power density of the radiation which is emitted by the radiation source is compensated for. The reference signal represents for example an irradiance and/or a spectral power density of the radiation emitted by the radiation source. The useful signal represents for example a portion of the radiation emitted by the radiation source which has penetrated through the sample to be examined. As an alternative, the useful signal represents for example a portion of the radiation emitted by the radiation source which has been reflected by the sample to be examined.

In a further advantageous embodiment, the evaluation and control unit is co-ordinated in such a way that the evaluation signal generated, in the case of a neutral sample, has a substantially constant value over the tuned predetermined spectral range. The evaluation signal generated deviates from the constant value if the sample to be examined has a reflection gradient and/or a transmission gradient in the tuned predetermined spectral range. The deviation of the evaluation signal generated advantageously supplies, in the predetermined spectral range, information about the concentration of the substance which leads to the deviation and which is contained in the sample to be examined. The emission wavelength and the associated thermal shift in the emission wavelength of the light emitting diode used advantageously correspond to the spectral behavior of the substance to be determined in the sample to be examined, such that the presence or the concentration of the predetermined substance can be reliably determined.

The evaluation and control unit drives the radiation source for example by means of a driver circuit, which generates a pulsed current that heats a chip of the light emitting diode by means of inherent heating, wherein the temperature of a chip carrier is kept substantially constant, in particular by means of corresponding cooling means, embodied for example as thermoelectric elements. The high dynamic range of the light emitting diode chip with regard to the chip carrier is advantageously utilized during the heating of the light emitting diode chip with the pulsed current. While the light emitting diode chip is heated very rapidly by the electrical power loss converted in it, the large mass and/or heat capacity of the chip carrier brings about a relatively small increase in temperature of the chip carrier in the case of the momentary heating of the light emitting diode chip. This means that an averaging of the temperature is brought about on the chip carrier given a corresponding distance from the light emitting diode chip. This average temperature of the chip carrier can then be kept constant by the corresponding cooling means.

In addition or as an alternative, the evaluation and control unit can turn off the light emitting diode by means of the driver circuit and evaluate a persistence phase of the light emitting diode, during which a diffusion capacitance continues to supply the light emitting diode and the chip of the light emitting diode cools. As a result of the cooling of the light emitting diode chip, the emission wavelength of the emitted radiation, as already explained above, can be altered from the upper emission wavelength to the lower emission wavelength. This time period corresponds to a reverse recovery time of the light emitting diode.

In a further advantageous embodiment, the evaluation and control unit, during the dynamic change in temperature of the light emitting diode, detects the reference signal and the useful signal at least two measurement instants and evaluates the signals. A first measurement instant, which correlates with a short emission wavelength of the light emitting diode, can be determined for example at the beginning of the heating process. A second measurement instant, which correlates with a longer emission wavelength of the light emitting diode, can be determined at the end of the heating process. As an alternative, a first measurement instant, which correlates with a long emission wavelength of the light emitting diode, can be determined for example at the beginning of the cooling process. A second measurement instant, which correlates with a shorter emission wavelength of the light emitting diode, can be determined at the end of the cooling process. In addition, it is possible for the evaluation and control unit to detect and evaluate the reference signal and the useful signal continuously between the first and second measurement instants.

The apparatus according to the invention can be used for example for determining the concentration of free water and/or of bound water in the sample to be examined.

By means of the method according to the invention for the spectral diagnosis of substances and/or surfaces, a sample to be examined is irradiated with a radiation which is emitted by a light emitting diode and the emission wavelength of which lies in a predetermined spectral range. The emission wavelength is shifted by means of a dynamic change in temperature of the light emitting diode between a first emission wavelength and a second emission wavelength, wherein a first portion of the emitted radiation is detected as a reference signal and a second portion of the emitted radiation, said second portion being influenced by the sample to be examined, is detected as a useful signal and evaluated. The reference signal is evaluated for the purpose of compensating for errors. The dynamic change in temperature of the light emitting diode corresponds for example to a dynamic heating of the light emitting diode, whereby the emission wavelength of the emitted radiation can be altered from a lower emission wavelength to an upper emission wavelength. In addition or as an alternative, the dynamic change in temperature of the light emitting diode can correspond to a dynamic cooling of the light emitting diode, whereby the emission wavelength of the emitted radiation can be altered from the upper emission wavelength to the lower emission wavelength.

Further advantageous configurations and developments of the invention emerge from the remaining dependent claims. Exemplary embodiments of the invention are illustrated below in principle with reference to the drawing.

### BRIEF DESCRIPTION OF THE DRAWINGS

In the figures:

FIG. 1 shows a schematic block diagram of a first embodiment of the apparatus according to the invention for the spectral diagnosis of substances and/or surfaces;

FIG. 2 shows a schematic block diagram of a second embodiment of the apparatus according to the invention for the spectral diagnosis of substances and/or surfaces;

FIG. 3 shows a schematic characteristic curve diagram for illustrating a driving current;

FIG. 4 shows a schematic characteristic curve diagram for illustrating a spectral emission generated by the driving current in accordance with FIG. 3;

FIG. 5 shows a schematic characteristic curve diagram for illustrating a maximum irradiance as a function of the driving current;

FIG. 6 shows schematic characteristic curve diagrams for illustrating spectral absorption characteristics of a first exemplary sample;

FIG. 7 shows schematic characteristic curve diagrams for illustrating spectral absorption characteristics of a second exemplary sample;

FIG. 8 shows schematic characteristic curve diagrams for illustrating spectral absorption characteristics of a third exemplary sample;

FIG. 9 shows schematic characteristic curve diagrams for illustrating spectral absorption characteristics of a fourth exemplary sample; and

FIG. 10 shows schematic characteristic curve diagrams for illustrating spectral absorption characteristics of a fifth exemplary sample.

### DETAILED DESCRIPTION OF THE INVENTION

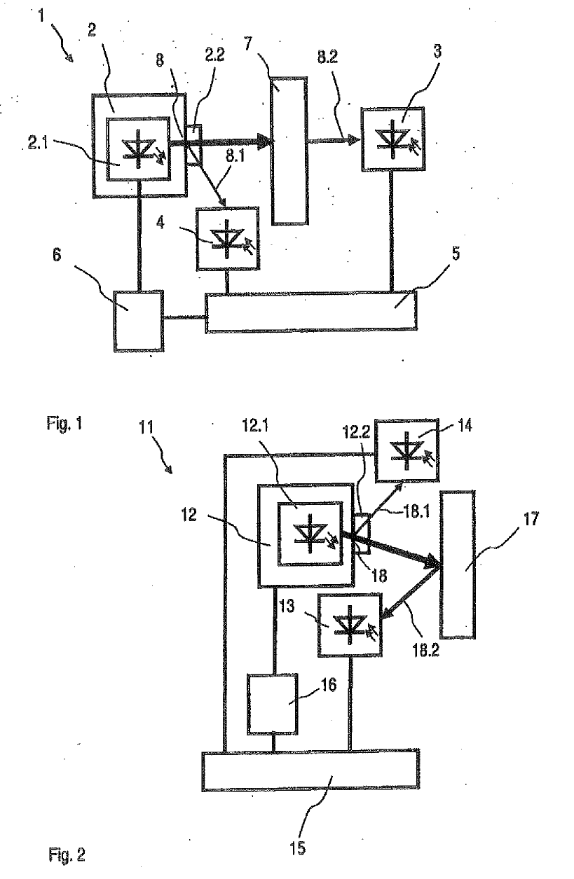

FIG. 1 shows a first exemplary embodiment of an apparatus 1 according to the invention for the spectral diagnosis of substances and/or surfaces, comprising a radiation source 2 having a light emitting diode 2.1, a first optical sensor unit 3, a second optical sensor unit 4, an evaluation and control unit 5 and a driver circuit 6. The first and second optical sensor units 3 and 4 are embodied for example in each case as a photodiode having a spectral sensitivity tuned to a predetermined spectral range. The emitted radiation 8 of the light emitting diode 2.1 is substantially focused onto the sample 7 to be examined and can be tuned in a predetermined spectral range SB, which is illustrated in FIG. 4. The predetermined emission wavelength of the light emitting diode 2.1 can be altered by means of a dynamic change in temperature of the light emitting diode 2.1 within the predetermined spectral range SB between a lower emission wavelength λ₁ and an upper emission wavelength λ₃. Thus, the emission wavelength λ of the emitted radiation can be altered for example by means of a dynamic heating of the light emitting diode 2.1 from the lower emission wavelength λ₁ to the upper emission wavelength λ₃. In addition or as an alternative, the emission wavelength λ of the emitted radiation can be altered for example by means of a dynamic cooling of the light emitting diode 2.1 from the upper emission wavelength λ₃ to the lower emission wavelength 2.

The first optical sensor unit 3 detects a portion of the radiation, said portion being influenced by the sample 7 to be examined, as a useful signal 8.2 and converts the latter into an electrical signal, and the second optical sensor unit 4 detects a second portion of the emitted radiation 8 as a reference signal 8.1, which is coupled out from the emitted radiation 8 by means of an optical coupling apparatus 2.2, for example, represents an irradiance and/or a spectral power density of the radiation 8 emitted by the light emitting diode 2.1 and is converted into an electrical signal. In the first embodiment, the useful signal 8.2 represents a portion of the radiation 8 emitted by the light emitting diode 2 which has penetrated through the sample 7 to be examined.

As can be seen from FIG. 2, a second exemplary embodiment of an apparatus 11 according to the invention for the spectral diagnosis of substances and/or surfaces comprises, analogously to the first exemplary embodiment, a radiation source 12 having a light emitting diode 12.1, a first optical sensor unit 13, a second optical sensor unit 14, an evaluation and control unit 15 and a driver circuit 16. The first and second optical sensor units 13 and 14 can likewise be embodied as photodiodes having spectral sensitivities tuned to the predetermined spectral range. Analogously to the first exemplary embodiment, the emitted radiation 18 from the light emitting diode 12.1 is focused onto the sample 17 to be examined and is tuned in a predetermined spectral range SB, wherein the predetermined emission wavelength of the light emitting diode 12.1 can be altered by means of a dynamic change in temperature of the light emitting diode 12.1 within the predetermined spectral range SB between the lower emission wavelength λ¹ and the upper emission wavelength λ₃. In contrast to the first exemplary embodiment in accordance with FIG. 1, the second exemplary embodiment of the apparatus according to the invention in accordance with FIG. 2 is not operated by means of a transmission method, but rather by means of a reflection method, that is to say that the first optical sensor unit 13 detects a portion of the radiation, said portion being reflected from the sample 17 to be examined, as a useful signal 18.2 and converts the latter into an electrical signal. Analogously to the first exemplary embodiment in accordance with FIG. 1, the second optical sensor unit 14 detects a second portion of the emitted radiation 18 as a reference signal 18.1, which is coupled out from the emitted radiation 18 by means of an optical coupling apparatus 12.2, for example, and converts said signal into an electrical signal, such that the evaluation and control unit 15 can carry out an error compensation.

Since the first and second exemplary embodiments comprise the same components and differ only in the detection of the useful signals 8.2 and 18.2, the modes of functioning of the two exemplary embodiments of the apparatus according to the invention for the spectral diagnosis of substances and/or surfaces are described jointly below with reference to FIGS. 1 to 5, where the functioning will be described on the basis of the example of a dynamic heating of the light emitting diode 2.1, 12.1 and an associated shift in the emission wavelength λ from the lower emission wavelength λ₁ to the upper emission wavelength λ₃.

The light emitting diode 2.1, 12.1 used as the radiation source 2, 12 comprises a chip as the actual radiation source, which chip is referred to hereinafter as light emitting diode chip, said chip being arranged on a carrier material, which is referred to hereinafter as chip carrier. In order to be able to assign a specific spectral emission characteristic to the light emitting diode 2.1, 12.1 used in the radiation source, the light emitting diode 2.1, 12.1 is operated at a defined temperature, where the temperature which sets the spectral characteristic of the light emitting diode 2.1, 12.1 is the temperature of the light emitting diode chip. The latter exhibits a high dynamic range depending on its heat capacity and thermal conductivity with respect to the chip carrier. In other words, the light emitting diode chip is heated rapidly when for example an electrical power loss is converted in it. By contrast, on account of its greater mass and/or higher specific heat capacity, the chip carrier generally has a significantly higher heat capacity than the light emitting diode chip and hence significantly higher thermal time constants.

This means that an averaging of the temperature is brought about on the chip carrier given a corresponding distance from the light emitting diode chip. In addition, the high heat capacity of the chip carrier brings about a relatively small increase in temperature in the case of the momentary heating of the light emitting diode chip. Said heat capacity of the chip carrier can therefore take up the power loss momentarily introduced into the chip as heat flow without appreciably being heated.

The average temperature of the chip carrier corresponds to the minimum temperature that can be attained at the beginning of the heating of the light emitting diode chip. This average temperature of the chip carrier can be reduced by an additional cooling in order to be able to tune a larger wavelength range, since a maximally possible temperature of the light emitting diode chip is limited to fixed values if the desire is to avoid premature aging or degradation of the light emitting diode chip. The substantially constant temperature of the chip carrier corresponds for example to an ambient temperature of the apparatus 1, 11 and can be equal to room temperature. In addition, it is possible to cool the chip carrier by means of a thermoelectric element, e.g. by means of a Peltier element, and to operate it at a predetermined lower temperature than room temperature.

The radiation source 2, 12 is driven with comparatively high, pulsed currents I_{LED} by means of the driver circuit 5, 15. This operating mode leads to a dynamic heating of the chip of the light emitting diode 2.1, 12.1, said chip being heated by inherent heating. In the case of the light emitting diode 2.1, 12.1, said dynamic heating leads to a shift in the emission wavelength. The chip of the light emitting diode 2.1, 12.1 is heated for a very short time period in the range of a few hundred nanoseconds and is cooled to the temperature of the chip carrier 2, 12 again during a longer subsidence time, wherein the subsidence time period is a few microseconds. Consequently, the chip of the light emitting diode 2.1, 12.1 is heated during a short pulse duration, wherein the mark-space ratio can be flexibly adapted to the application. The pulse duration of the current pulse is dependent for example on the thermal time constant of the light emitting diode chip, the maximum permissible chip temperature and the power loss converted. A short heating time period affords a further advantage that very high operating currents can be applied, which enable very high radiation powers for the emitted radiation 8, 18.

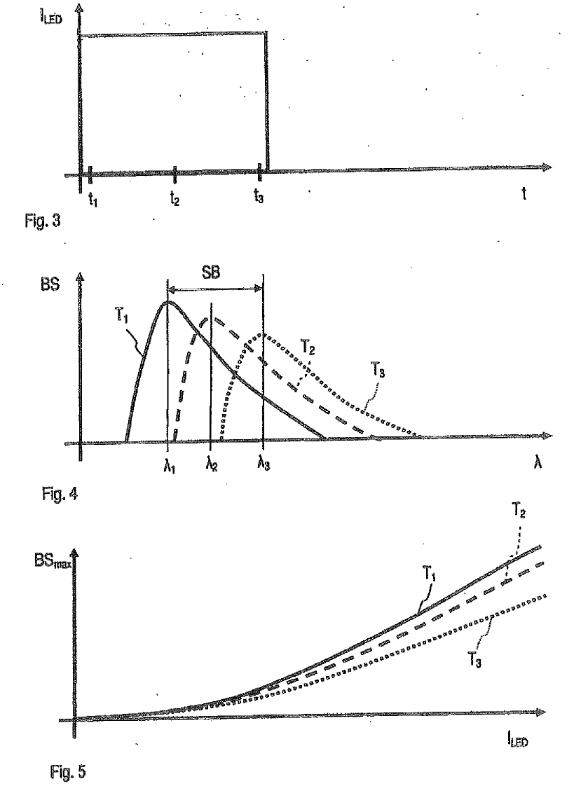

The relationship between the temporal profile of the pulsed current I_{LED} and a spectral distribution of the irradiance BS of the emitted radiation 8, 18 is illustrated schematically in FIGS. 3 to 5.

FIG. 3 shows a profile of the pulsed current I_{LED} for a heating process. Thus, by way of example, a first chip temperature T₁ of the light emitting diode 2.1, 12.1 is established by inherent heating at a first instant t₁, a second chip temperature T₂ of the light emitting diode 2.1, 12.1 is established at an instant t₂, and a third chip temperature T₃ of the light emitting diode 2.1, 12.1 is established at a third instant t₃.

As can be seen from FIG. 4, the emission wavelength of the radiation 8, 18 emitted by the light emitting diode 2.1, 12.1 is shifted by the dynamic heating. Thus, by way of example the first chip temperature T₁ causes a lower emission wavelength the second chip temperature T₂ causes a second emission wavelength λ₂ and the third chip temperature T₃ causes an upper emission wavelength λ₂, of the radiation 8, 18 emitted by the light emitting diode 2.1, 12.1. The shift in the emission wavelength that is caused by the heating, that is to say the wavelength range between the lower emission wavelength λ₁, and the upper emission wavelength λ₃, is wavelength-dependent and lies in the range of 80 to 100 nm given an average emission wavelength λ₂ of 1400 nm.

As a side effect, however, the heating of the light emitting diode 2.1, 12.1 leads to a reduction of the emitted maximum irradiance BSₘₐₓ given a constant operating current Iₘₘ, as can be seen from FIG. 5. For this reason, the irradiance BS of the radiation 8, that is emitted by the light emitting diode 2.1, 12.1 and used to irradiate the sample 7, 17 to be examined is detected by means of the second sensor unit 4, 14, which makes the reference signal 8.1, 18.1 available.

The evaluation and control unit 5, 15 relates the detected useful signal 8.2, 18.2 and the detected reference signal 8.1, 18.1 to one another for error compensation purposes and generates an evaluation signal, preferably a quotient signal, for the purpose of further evaluation. The evaluation and control unit 5, 15 can comprise for example a microcontroller with an analog-to-digital converter. However, a purely analog accounting of the useful signal 8.2, 18.2 and of the reference signal 8.1, 18.1 is also conceivable. In the evaluation signal generated, the thermal dependence of the irradiance and/or the thermal dependence of the spectral power density of the radiation 8, 18 emitted by the light emitting diode 2.1, 12.1 are compensated for, such that during an examination of a neutral sample, in the time range between the measurement instants t₁ and t₃, the evaluation signal has a substantially constant signal profile. However, if the sample 7, 17 to be examined has a gradient in the reflection or respectively transmission behavior in the tuned spectral range SB, then the evaluation signal deviates from the constant value. This deviation supplies information about the concentration of the substance leading to the deviation in the sample 7, 17 to be examined in the wavelength range SB examined.

During the heating process the evaluation and control circuit 5, 15 detects signals at least two measurement instants t₁, t₂, t₃. As can be seen from FIG. 4, the first measurement instant t₁ can be determined at the beginning of the heating process and is therefore correlated with a short emission wavelength of the emitted radiation 8, 18. A second measurement instant t₂ can be determined for example in the middle of the heating process and a third measurement instant t₃ can be determined for example toward the end of the heating process and is therefore correlated with a longer emission wavelength of the emitted radiation 8, 18 than at the first measurement instant t₁. During such a measurement cycle, the emission wavelength of the emitted radiation 8, 18 is shifted, or tuned, from short toward longer wavelengths. As an alternative, the reference signal 8.1, 18.1 and the useful signal 8.2, 18.2 can be detected and evaluated continuously between the first and third measurement instants t₁ and t₃.

In order to be able to determine the concentration of the predetermined substance in the sample 7, 17 to be analyzed, the sample 7, 17 to be analyzed has a gradient in the absorption or respectively reflection behavior in the tuned wavelength range. This property makes it possible, by means of the described apparatus in the tuned wavelength range SB, to transform the wavelength-dependent transmission or reflection behavior of the sample 7, 17 to be examined into a time-dependent behavior. The latter can be detected and processed very easily by the evaluation and control unit 5, 15. In order to determine the concentration of the predetermined substance in the sample 7, 17 to be examined, a light emitting diode 2.1, 12.1 is chosen which has an emission wavelength and an associated thermal shift in the emission wavelength which correspond to the spectral behavior of the predetermined substance to be detected.

The information determined by the dynamic heating of the light emitting diode 2.1, 12.1 and an associated shift in the emission wavelength λ from the lower emission wavelength λ₁ to the upper emission wavelength λ₃ can be determined analogously by a dynamic cooling of the light emitting diode 2.1, 12.1 and an associated shift in the emission wavelength λ from the upper emission wavelength λ₃ to the lower emission wavelength λ₁. The light emitting diodes 2.1, 12.1 in the near infrared range (NIR), in particular, exhibit persistence additionally for a few microseconds after the operating current has been turned off. Said persistence is supplied by a diffusion capacitance of the light emitting diode 2.1, 12.1 until the latter has been discharged. This time period corresponds to the reverse recovery time of the light emitting diode 2.1, 12.1. During the persistence of the light emitting diode 2.1, 12.1, the light emitting diode 2.1, 12.1 cools, such that the emission wavelength λ of the emitted radiation is correspondingly shifted from the upper emission wavelength λ₃ to the lower emission wavelength λ₁.

The apparatus according to the invention and the method according to the invention can be used for example for determining the concentration of free water and/or bound water in a sample 7, 17 to be examined. Thus, the invention can be used for example for determining, during the production of a product, the current moisture content of a product sample 7, 17 to be examined.

FIGS. 6 to 10 show various schematic characteristic curve diagrams, for describing the use of the apparatus according to the invention or of the method according to the invention. FIG. 6 shows for example the behavior of a product during production and the decrease in the moisture content in the product.

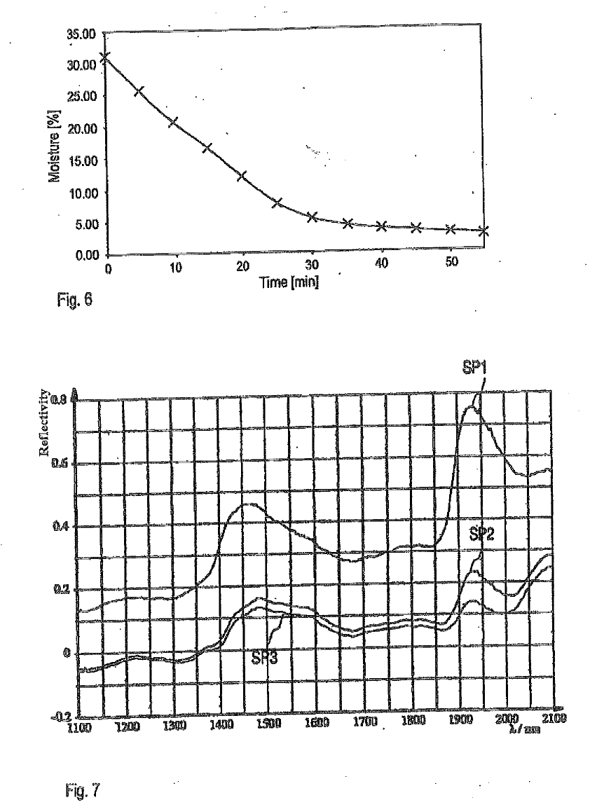

FIG. 7 shows non-normalized characteristic curves of three spectra SP1, SP2 and SP3 of a sample which were recorded at different concentrations of the constituent to be analyzed (in this case water) by means of a grating spectrometer. The physically problematic negative value for the reflectivity as illustrated in FIG. 7 is attributed to the fact that FIG. 7 is a non-normalized illustration with an offset.

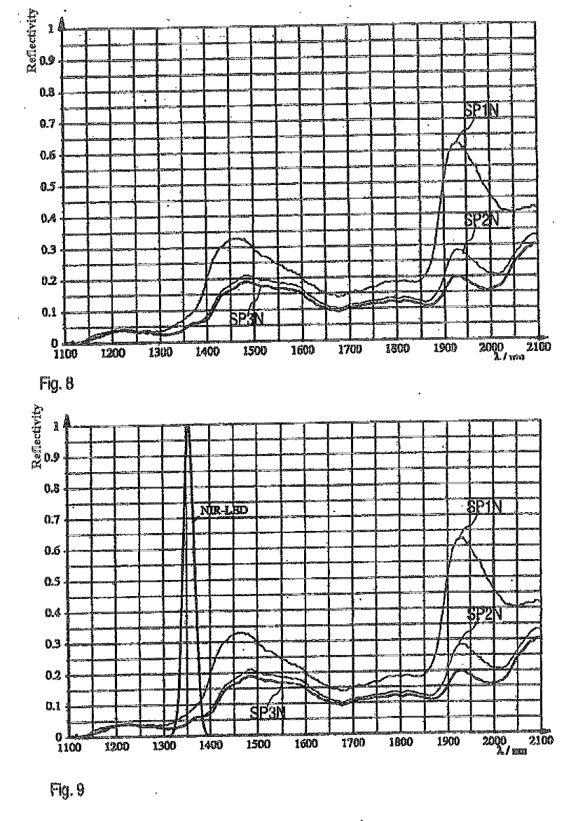

The data of the three spectra SP1, SP2 and SP3 from FIG. 7 are firstly normalized in such a way that the associated characteristic curves have the value 0 at a wavelength λ=1100 nm and negative values for the reflectivity thus no longer occur. FIG. 8 shows the corresponding characteristic curves of the normalized spectra SP1N, SP2N, SP3N of the three spectra SP1, SP2 and SP3 illustrated in FIG. 7.

FIG. 9 shows the characteristic curves of the normalized spectra SPIN, SP2N, SP3N superimposed by a characteristic curve NIR-LED, which represents the normalized irradiance of a commercial light emitting diode 12.1 in the near infrared range (NIR), in the wavelength range of around λ=1350 nm to 1400 nm. Both the reflectivity of the samples and, for the NIR-LED, the normalized irradiance are plotted along the ordinate.

Upon the tuning of the wavelength of the light emitting diode 12.1 LED, the first optical sensor unit detects the irradiance—weighted with the reflection spectrum—of the light emitting diode 12.1 integrally over the wavelength λ. A sensor signal X_{sens(̂)} of the first optical sensor unit 13 is therefore proportional to the radiation power integrated over the optically active area, of the radiation influenced by the sample 17, here the radiation reflected from the sample 17.

The sensor signal X_{sens(̂)} as a function of the wavelength shift λ of the tuned light emitting diode 12.1 is therefore proportional to a convolution integral in accordance with equation (1).

$${x}_{sens ( ⋀ )} - {\int }_{- ∞}^{+ ∞} {S }_{( λ )} * {R}_{( λ - ⋀ )} d λ \qquad ( 1 )$$

Where S_{(λ)} represents the normalized spectral irradiance of the light emitting diode 12.1 and R_{(λ)} represents the spectral reflectivity of the sample 17.

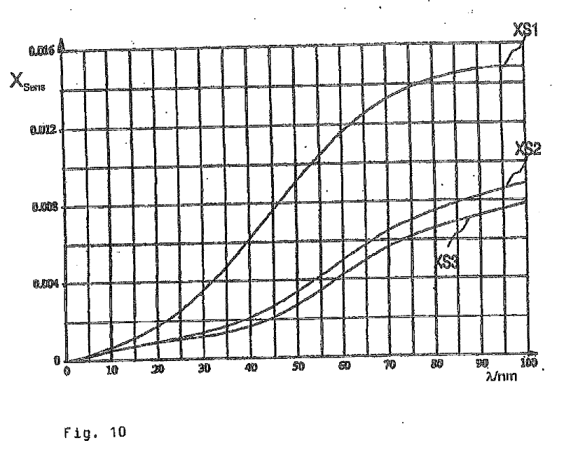

FIG. 10 shows three characteristic curves XS1, XS2, XS3 representing the result of the convolution integral according to equation (1) of the spectral characteristic SPIN, SP2N, SP3N of the sample 17 with the spectral radiation density NIR-LED of the corresponding light emitting diode 12.1, that is to say a cross-correlation, for the tuning range ̂<100 nm of the light emitting diode 12.1. The first optical sensor unit 14 supplies a corresponding proportional signal. A comparable signal can also be calculated from the quotient of useful signal 18.2 and reference signal 18.1. A signal with arbitrary scaling as a function of the change in wavelength of the light emitting diodes 12.1 is thus determined. For typical light emitting diodes 12.1 in the NIR range of the corresponding wavelength, a tuning range of ̂˜80 nm can be expected in practice. Corresponding results can alternatively be obtained with the embodiment of the apparatus 1 according to the invention for the spectral diagnosis of substances and/or surfaces which is illustrated in FIG. 1.

The apparatus according to the invention and the method according to the invention for the spectral diagnosis of substances and/or surfaces advantageously enables a very simple and cost-effective arrangement for spectral measurement in a limited wavelength range, wherein customary light emitting diodes which are commercially available with emission wavelengths between the far UV range and the IR range can be used as the radiation source. The present invention essentially utilizes the thermal wavelength dependence of the semiconductor radiation sources in conjunction with differential measurement technology.

I claim:

1. An apparatus for the spectral diagnosis of substances and/or surfaces comprising a radiation source, which can be tuned in a predetermined spectral range and the emitted radiation of which is substantially focused onto a sample to be examined, said apparatus comprising a first optical sensor unit which: detects a first portion of the emitted radiation, said first portion being influenced by the sample to be examined, as a useful signal and forwards it to an evaluation and control unit, characterized in that the radiation source comprises a light emitting diode having a predetermined emission wavelength which can be altered by a dynamic change in temperature of the light emitting diode within the predetermined spectral range between a first emission wavelength and a second emission wavelength, wherein a second optical sensor unit detects a second portion of the emitted radiation as a reference signal and forwards it to the evaluation and control unit for error compensation purposes.

2. The apparatus as claimed in claim 1, wherein the dynamic change in temperature of the light emitting diode corresponds to a dynamic heating of the light emitting diode which alters the emission wavelength from a lower emission wavelength to an upper emission wavelength.

3. The apparatus as claimed in claim 1, wherein the dynamic change in temperature of the light emitting diode, corresponds to a dynamic cooling of the light emitting diode, which alters the emission wavelength from the upper emission wavelength to the lower emission wavelength.

4. The apparatus as claimed in claim 1, wherein the evaluation and control unit relates the useful signal to the reference signal and, for further evaluation purposes, generates an evaluation signal in which the thermal dependence of the irradiance and/or the thermal dependence of the spectral power density of the radiation which is emitted by the radiation source is compensated for.

5. The apparatus as claimed in claim 1, wherein the reference signal represents at least one of, an irradiance and a spectral power density of the radiation emitted by the radiation source.

6. The apparatus as claimed in claim 1, wherein the useful signal represents a portion of the radiation emitted by the radiation source which has penetrated through the sample to be examined.

7. The apparatus as claimed in claim 1, wherein the useful signal represents a portion of the radiation emitted by the radiation source which has been reflected by the sample to be examined.

8. The apparatus as claimed in claim 4, wherein the evaluation and control unit is co-ordinated in such a way that the evaluation signal generated, in the case of a neutral sample, has a substantially constant value over the tuned predetermined spectral range.

9. The apparatus as claimed in claim 4, wherein the evaluation signal generated deviates from the constant value if the sample to be examined has a gradient in the tuned predetermined spectral range, wherein the deviation of the evaluation signal generated supplies information about a concentration of the substance leading to the deviation in the sample to be examined in the predetermined spectral range said gradient comprising at least one of, a reflection gradient and a transmission gradient.

10. The apparatus as claimed in claim 9, wherein the emission wavelength and the associated thermal shift in the emission wavelength of the light emitting diode correspond to the substance to be determined in the sample to be examined.

11. The apparatus as claimed in claim 1, wherein the evaluation and control unit drives the light emitting diode by means of a driver circuit, which generates a pulsed current that heats a chip of the light emitting diode by means of inherent heating.

12. The apparatus as claimed in claim 11, wherein during the heating of the light emitting diode chip the temperature of a chip carrier is kept substantially constant, in particular by means of corresponding coolants.

13. The apparatus as claimed in claim 11, wherein the evaluation and control unit turns off the light emitting diode by means of the driver circuit and evaluates a persistence phase of the light emitting diode, during which a diffusion capacitance continues to supply the light emitting diode and the chip of the light emitting diode cools.

14. The apparatus as claimed in claim 1, wherein the evaluation and control unit detects and evaluates the reference signal and the useful signal at least two measurement instants during the dynamic change in temperature of the light emitting diode.

15. The apparatus as claimed in claim 10, wherein a first measurement instant (t₁) is determined at the beginning of the heating process, which correlates with a short emission wavelength of the light emitting diode, and a second measurement instant (t₃) is determined at the end of the heating process, which correlates with a longer emission wavelength of the light emitting diode.

16. The apparatus as claimed in claim 10, wherein a first measurement instant is determined at the beginning of the cooling process, which correlates with a long emission wavelength of the light emitting diode, and a second measurement instant is determined at the end of the cooling process, which correlates with a shorter emission wavelength of the light emitting diode.

17. The apparatus as claimed in claim 14, wherein the evaluation and control unit detects and evaluates the reference signal and the useful signal continuously between the first and second measurement instants.

18. The apparatus as claimed in claim 1, wherein free water and/or bound water is predetermined as substance to be determined in the sample to be examined.

19. A method for the spectral diagnosis of substances and/or surfaces, characterized by the following steps:
irradiating a sample to be examined with a radiation which is emitted by a light emitting diode and the emission wavelength of which lies in a predetermined spectral range, and shifting the emission wavelength by means of a dynamic change in temperature of the light emitting diode from a first emission wavelength to a second emission wavelength, wherein a first portion of the emitted radiation is detected and evaluated as a reference signal and a second portion of the emitted radiation, said second portion being influenced by the sample to be examined, is detected and evaluated as a useful signal, wherein the reference signal is evaluated for the purpose of compensating for errors.

20. The method as claimed in claim 19, wherein the dynamic change in temperature of the light emitting diode corresponds to a dynamic heating of the light emitting diode which alters the emission wavelength from a lower emission wavelength to an upper emission wavelength.

21. The method as claimed in claim 19, wherein the dynamic change in temperature of the light emitting diode, corresponds to a dynamic cooling of the light emitting diode, which alters the emission wavelength from the upper emission wavelength to the lower emission wavelength.

22. The method as claimed in claim 19, wherein the useful signal is related to the reference signal and, for further evaluation purposes, an evaluation signal is generated in which the thermal dependence of the irradiance and/or the thermal dependence of the spectral power density of the emitted radiation is compensated for.

23. The method as claimed in claim 19, wherein the reference signal represents an irradiance.

24. The method as claimed in claim 19, wherein the useful signal represents a portion of the emitted radiation which has penetrated through the sample to be examined or has been reflected by the sample to be examined.

25. The method as claimed in claims 19, wherein information about a concentration of a specific substance contained in the sample to be examined is determined by means of a deviation of the evaluation signal generated from a constant value, wherein the substantially constant value of the evaluation signal generated occurs upon the irradiation of a neutral sample, and the deviation from this neutral value occurs by virtue of the fact that the sample to be examined has a reflection gradient and/or a transmission gradient in the tuned predetermined spectral range.

26. The method as claimed in claim 25, wherein in order to determine the concentration of the predetermined substance in the sample to be examined, a light emitting diode is chosen which has an emission wavelength and an associated thermal shift in the emission wavelength which correspond to the spectral behavior of the predetermined substance.

27. The method as claimed in claim 19, wherein an ambient temperature of the radiation source is kept substantially constant and the temperature of a chip of the light emitting diode is dynamically increased by means of a pulsed current flow.

28. The apparatus as claimed in claim 19, wherein the light emitting diode is turned off and a persistence phase of the light emitting diode is evaluated, during which a diffusion capacitance continues to supply the light emitting diode and the chip of the light emitting diode is cooled.

29. The method as claimed in claim 19, wherein the reference signal and the useful signal are detected and evaluated at least two measurement instants during the heating of the light emitting diode.

30. The method as claimed in claim 29, wherein a first measurement instant is determined at the beginning of the heating process, which correlates with a short emission wavelength of the emitted radiation, and a second measurement instant is determined at the end of the heating process, which correlates with a longer emission wavelength of the emitted radiation.

31. The apparatus as claimed in claim 29, wherein a first measurement instant is determined at the beginning of the cooling process, which correlates with a long emission wavelength of the emitted radiation, and a second measurement instant is determined at the end of the cooling process, which correlates with a shorter emission wavelength of the emitted radiation.

32. The method as claimed in claim 29, wherein the reference signal and the useful signal are detected and evaluated continuously between the first and second measurement instants.

33. The method as claimed in claim 19, wherein the concentration of free water and/or of bound water in a sample to be examined is determined, wherein the predetermined spectral range preferably includes an absorption band of water.

34. The method of claim 19, wherein the reference signal represents a spectral power density of the emitted radiation.
